(19) United States
(12) Patent Application Publication
(10) Pub. No.: US 2025/0245249 A1
(43) Pub. Date: Jul. 31, 2025

(54) AUGMENTING SEMANTIC SEARCH SCORES BASED ON RELEVANCY AND POPULARITY

(71) Applicant: Intuit Inc., Mountain View, CA (US)

(72) Inventors: Saikiran Sri THUNUGUNTLA, Bangalore (IN); Vignesh RADHAKRISHNAN, Bangalore (IN); Anishkumar SS, Chennai (IN); Chaitra RAO, Bangalore (IN)

(73) Assignee: Intuit Inc., Mountain View, CA (US)

(21) Appl. No.: 18/428,790

(22) Filed: Jan. 31, 2024

(51) Int. Cl. G06F 16/332; G06F 16/33; G06F 16/383; G06F 40/284

(52) U.S. Cl. CPC G06F 16/3329; G06F 16/3347; G06F 16/383; G06F 40/284

(57) ABSTRACT

Systems and methods for generating augmented search results are disclosed. An example method is performed by one or more processors of a search results ranking system and includes receiving a transmission over a communications network from a computing device associated with a user of the search results ranking system, the transmission including a search query, submitting, to a vector database, a token query matching a tokenized version of the search query against a plurality of data assets, submitting, to the vector database, one or more vector queries matching a vectorized version of the search query against the plurality of data assets, identifying, based on results of the token query and the one or more vector queries, contextually relevant results among the plurality of data assets, and generating augmented search results for the search query based on the contextually relevant results.

### CROSS-REFERENCE TO RELATED APPLICATION

This application is related to U.S. patent application Ser. No. 17/510,714 (now U.S. Pat. No. 11,630,829) entitled “AUGMENTING SEARCH RESULTS BASED ON RELEVANCY AND UTILITY” and filed on Oct. 26, 2021, which is assigned to the assignee hereof. The disclosures of all prior Applications are considered part of and are incorporated by reference in this patent application.

### TECHNICAL FIELD

This disclosure relates generally to augmenting search results, and specifically to generating augmented semantic search scores based on relevancy and popularity.

### DESCRIPTION OF RELATED ART

Organizations often provide users with access to data assets, such as documents, hive tables, glossaries, and the like. The data assets may be stored and managed in various databases, such as data catalogs or other suitable data repositories. Metadata associated with the data assets may also be stored by the organization, such as data stored in a data lake, relational sources, an event bus, various reports, machine learning (ML) features, developer portals, or the like. Additionally, organizations often enable users to search among and within the data assets. For example, search algorithms used in conjunction with a data catalog may be used to effectively perform pattern-matching based searches for data assets using specific keywords. Users may also utilize tools like Apache Atlas to search the metadata associated with the data assets. For instance, a user may use Apache Atlas to search metadata fields associated with hive tables, such as “title,” “description,” “lastAccessTime,” “name,” and “owner” fields.

However, conventional data asset search methods still primarily rely on keyword searches, often requiring users to have familiarity with relevant entity-specific keywords and/or search APIs. Furthermore, keyword-based searches, while effective for small datasets, often generate many irrelevant results for large datasets, which can waste organizational resources and users' time and effort. To address these issues, some organizations have enhanced default search functionalities by incorporating additional metadata into their search platforms. Specifically, recent improvements in data asset search techniques have combined traditional algorithms (e.g., term frequency-inverse document frequency (tf-idf)) with popularity scores and usage statistics to address various tokenization issues caused by characters (e.g., underscores, hyphens, percentages, and the like) within search terms that can diminish the quality of search results.

Nonetheless, improvements to data asset search techniques are still needed, particularly for new users that are unfamiliar with specific keywords associated with the data assets. What is needed is a data asset search system that can allow users to search for what they want without already having specialized familiarity with the potential results. An optimum system would enable users to intuitively and efficiently navigate metadata, discover data assets, generate insights, and solve ML use cases, for examples. Furthermore, there is a need for increased user friendliness in search systems that allows for various types of user queries beyond basic keyword searches.

### SUMMARY

This Summary is provided to introduce in a simplified form a selection of concepts that are further described below in the Detailed Description. This Summary is not intended to identify key features or essential features of the claimed subject matter, nor is it intended to limit the scope of the claimed subject matter. Moreover, the systems, methods, and devices of this disclosure each have several innovative aspects, no single one of which is solely responsible for the desirable attributes disclosed herein.

One innovative aspect of the subject matter described in this disclosure can be implemented as a computer-implemented method for generating augmented search results. An example method is performed by one or more processors of a system and includes receiving a transmission over a communications network from a computing device associated with a user of the search results ranking system, the transmission including a search query, submitting, to a vector database, a token query matching a tokenized version of the search query against a plurality of data assets, submitting, to the vector database, one or more vector queries matching a vectorized version of the search query against the plurality of data assets, identifying, based on results of the token query and the one or more vector queries, contextually relevant results among the plurality of data assets, and generating augmented search results for the search query based on the contextually relevant results.

Another innovative aspect of the subject matter described in this disclosure can be implemented in a system for generating augmented search results. An example system includes one or more processors and a memory storing instructions for execution by the one or more processors. Execution of the instructions causes the system to perform operations including receiving a transmission over a communications network from a computing device associated with a user of the search results ranking system, the transmission including a search query, submitting, to a vector database, a token query matching a tokenized version of the search query against a plurality of data assets, submitting, to the vector database, one or more vector queries matching a vectorized version of the search query against the plurality of data assets, identifying, based on results of the token query and the one or more vector queries, contextually relevant results among the plurality of data assets, and generating augmented search results for the search query based on the contextually relevant results.

Another innovative aspect of the subject matter described in this disclosure can be implemented as a non-transitory computer-readable medium storing instructions that, when executed by one or more processors of a system for generating augmented search results, cause the system to perform operations. Example operations include receiving a transmission over a communications network from a computing device associated with a user of the search results ranking system, the transmission including a search query, submitting, to a vector database, a token query matching a tokenized version of the search query against a plurality of data assets, submitting, to the vector database, one or more vector queries matching a vectorized version of the search query against the plurality of data assets, identifying, based on results of the token query and the one or more vector queries, contextually relevant results among the plurality of data assets, and generating augmented search results for the search query based on the contextually relevant results.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows a system, according to some implementations.

FIG. 2 shows a high-level overview of an example process flow employed by a system, according to some implementations.

FIG. 3 shows a high-level overview of an example process flow employed by a system, according to some implementations.

FIG. 4 shows a high-level overview of an example process flow employed by a system, according to some implementations.

FIG. 5 shows an illustrative flowchart depicting an example operation for generating augmented search results, according to some implementations.

Like numbers reference like elements throughout the drawings and specification.

### DETAILED DESCRIPTION

As described above, organizations provide users access to various data assets stored in databases (e.g., data catalogs, etc.), along with associated metadata, and often provide users with the ability to search among the data assets, such as by performing keyword-based searches, metadata searches using Apache Atlas, and the like. As conventional data asset search methods are primarily built for keyword-based search queries, inefficiencies and irrelevant search results are common, particularly when users search among large datasets. Although recent advancements in data asset search technologies have combined traditional algorithms with popularity scores to improve search quality, improvements are still needed, such as to better assist users that are unfamiliar with specialized keywords or characters, and to provide a more intuitive, user-friendly system that enables users to efficiently navigate and discover the data assets and metadata that are most relevant to and meaningful for their needs.

It is to be understood that the search rankings generated by the disclosed search results ranking system go beyond simply aggregating vectorized data associated with data assets and applying a basic vector distance metric for search results. Rather, the techniques disclosed herein provide several innovations that incorporate a combination of traditional and semantic search techniques, large language models (LLMs), vector construction, vector databases, vector search, and aggregated score computation that enables an enhanced search results ranking system to generate augmented search results-specifically, search results that accurately reflect the most relevant, meaningful, and popular data assets for a given search query based on pattern matching, semantic similarity, and popularity statistics, and ranked using a combination of multiple algorithms that incorporate scores for all of semantics, relevancy, and popularity. As one example further described below, the search results ranking system uses LLMs to generate contextual information (e.g., summaries) for data assets as well as questions that could be answered using such summaries. As another example, the search results ranking system generates contextual information based on user feedback about search results and user questions associated with such feedback. The contextual information is incorporated into vector databases that are used to augment semantic search scores, thereby enhancing search results for subsequent users that enter the same or similar questions.

In an example implementation, the search results ranking system receives a search query, matches a tokenized version and one or more vectorized versions of the search query in a vector database against a plurality of data assets, identifies contextually relevant results among the plurality of data assets based on results of the queries, and generates augmented search results based on the contextually relevant results. A sentence transformer is used to tokenize the search query and to vectorize the tokenized version of the search query. The token query matches the tokenized version of the search query against metadata stored in association with the data assets in a data catalog. An LLM is used to generate summaries and anticipated queries for the data assets, which are also tokenized, vectorized, and stored in the vector database. The vectorized summaries and vectorized sets of anticipated queries may be stored in the vector database as dense vector fields in the form of a hierarchical navigable small world (HNSW) graph. The augmented search results are generated in part based on the summaries and anticipated queries. The augmented search results are ranked based on a combination of results of the token query (e.g., in conjunction with a relevancy scoring algorithm), the one or more vector queries (e.g., in conjunction with a semantic scoring algorithm), and a popularity subscore (e.g., in conjunction with a popularity scoring algorithm). In some instances, the search results ranking system receives user feedback about one or more augmented search results, vectorizes the feedback, and stores it as metadata for the corresponding data assets. In such instances, upon receiving a subsequent search query relevant to a corresponding data asset, the search results ranking system generates augmented search results based on the vectorized feedback (e.g., also in conjunction with the semantic scoring algorithm).

In these and other manners, the disclosed search results ranking system can determine a type or intent of a given search query, thereby going beyond an assumption that a query is a keyword search and allowing for the possibility that the query is a natural language request or question about data assets in general. That is, the innovative search results ranking system is configured to incorporate a semantic meaning of a user's query into the search ranking algorithm such that quality results can be generated in response to keyword-based queries and a variety of other query types, such as “abc_app_transaction_details”, “give me tables that have all abc transaction details”, “what are the tables that include details about abc transactions?”, among others. Other queries that the search results ranking system can effectively handle include, for example, “What are the tables that contain billing data of ABC App?”, “What are the most popular tables that are used for DEF App clickstream data?,” “Table that stores ABC App subscription data for the month of January 2023,” etc. By incorporating a context of a user's search query, the disclosed search results ranking system empowers users having varying degrees of familiarity (including no familiarity) with the potential search results to effectively and efficiently find the data assets for which they are searching, using a single search interface, and with the freedom to employ a querying style most intuitive to them in the moment.

Various implementations of the subject matter disclosed herein provide one or more technical solutions to the technical problem of improving the functionality (e.g., speed, accuracy, etc.) of computer-based systems, where the one or more technical solutions can be practically and practicably applied to improve on existing techniques for generating search results. Implementations of the subject matter disclosed herein provide specific inventive steps describing how desired results are achieved and realize meaningful and significant improvements on existing computer functionality—that is, the performance of computer-based systems operating in the evolving technological field of generating search results.

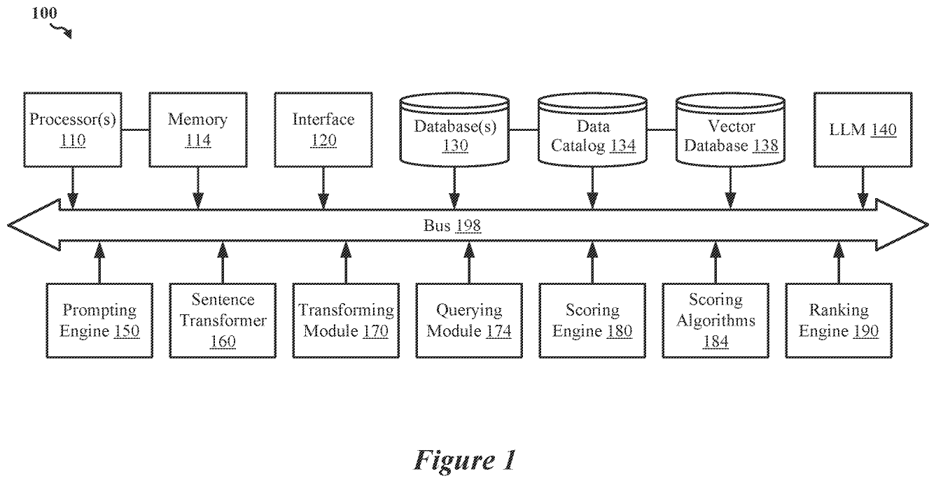

FIG. 1 shows a system 100, according to some implementations. Various aspects of the system 100 disclosed herein are generally applicable for generating augmented search results. The system 100 includes a combination of one or more processors 110, a memory 114 coupled to the one or more processors 110, an interface 120, one or more databases 130, a data catalog 134, a vector database 138, a large language model (LLM) 140, a prompting engine 150, a sentence transformer 160, a transforming module 170, a querying module 174, a scoring engine 180, one or more scoring algorithms 184, and/or a ranking engine 190. In some implementations, the various components of the system 100 are interconnected by at least a data bus 198. In some other implementations, the various components of the system 100 are interconnected using other suitable signal routing resources.

The processor 110 includes one or more suitable processors capable of executing scripts or instructions of one or more software programs stored in the system 100, such as within the memory 114. In some implementations, the processor 110 includes a general-purpose single-chip or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. In some implementations, the processor 110 includes a combination of computing devices, such as a combination of a DSP and a microprocessor, a plurality of microprocessors, one or more microprocessors in conjunction with a DSP core, or any other suitable configuration. In some implementations, the processor 110 incorporates one or more graphics processing units (GPUs) and/or tensor processing units (TPUs), such as for processing a large amount of data.

The memory 114, which may be any suitable persistent memory (such as non-volatile memory or non-transitory memory) may store any number of software programs, executable instructions, machine code, algorithms, and the like that can be executed by the processor 110 to perform one or more corresponding operations or functions. In some implementations, hardwired circuitry is used in place of, or in combination with, software instructions to implement aspects of the disclosure. As such, implementations of the subject matter disclosed herein are not limited to any specific combination of hardware circuitry and/or software.

The interface 120 is one or more input/output (I/O) interfaces for transmitting or receiving (e.g., over a communications network) transmissions, input data, and/or instructions to or from a computing device of a user, outputting data (e.g., over the communications network) to the computing device of the user, providing a search interface for the user, outputting search results to the computing device of the user, and the like. Specifically, the interface 120 may be used to receive search queries from users and/or to provide search results to users. For example, the interface 120 may be used to receive a transmission (e.g., including a search query entered by a user of the search results ranking system) over the communications network from a computing device associated with the user. As another example, the interface 120 may be used to transmit one or more augmented search results over the communications network to the computing device associated with the user. The interface 120 may also be used to receive user feedback about one or more of the search results, such as when a user clicks a “thumbs up” or “thumbs down” situated near one of the search results. The interface 120 may also be used to provide or receive other suitable information, such as computer code for updating one or more programs stored on the system 100, internet protocol requests and results, or the like. An example interface includes a wired interface or wireless interface to the internet or other means to communicably couple with user devices or any other suitable devices. In an example, the interface 120 includes an interface with an ethernet cable to a modem, which is used to communicate with an internet service provider (ISP) directing traffic to and from user devices and/or other parties. In some implementations, the interface 120 is also used to communicate with another device within the network to which the system 100 is coupled, such as a smartphone, a tablet, a personal computer, or other suitable electronic device. In various implementations, the interface 120 includes a display, a speaker, a mouse, a keyboard, or other suitable input or output elements that allow interfacing with the system 100 by a local user or moderator.

The database 130 stores data associated with the system 100, such as data objects, algorithms, weights, models, modules, engines, user information, values, ratios, historical data, recent data, current or real-time data, files, plugins, extracted data and/or metadata, arrays, tags, identifiers, prompts, queries, replies, feedback, insights, formats, characteristics, features, and/or components, among other suitable information, such as in one or more JavaScript Object Notation (JSON) files, comma-separated values (CSV) files, or other data objects for processing by the system 100, one or more Structured Query Language (SQL) compliant data sets for filtering, querying, and sorting by the system 100 (e.g., the processor 110), or any other suitable format. In various implementations, the database 130 is a part of or separate from the data catalog 134, the vector database 138, and/or another suitable physical or cloud-based data store. In some implementations, the database 130 includes a relational database capable of presenting information as data sets in tabular form and capable of manipulating the data sets using relational operators.

The data catalog 134 stores data associated with data assets, such as the data assets themselves, metadata associated with the data assets, or any other suitable data related to the data assets. Specifically, a plurality of data assets may be stored in the data catalog 134, and each of the plurality of data assets may be associated with at least some metadata in the data catalog 134. As further described below, the data catalog 134 (and/or the vector database 138) may be queried (e.g., using the querying module 174) based on a token query that matches a tokenized version of a search query against the metadata. In some implementations, the data catalog 134 incorporates one or more aspects of Apache Atlas or another suitable platform designed for data governance and metadata management (e.g., within a Hadoop environment) that allows organizations to manage data assets within a data ecosystem. For instance, in some other implementations, the data catalog 134 incorporates one or more aspects of Collibra, Alation, Microsoft Azure Data Catalog, Google Cloud Data Catalog, AWS Glue Data Catalog, or the like. In various implementations, the data catalog 134 may be a part of or separate from the database 130 and/or the vector database 138. In some instances, the data catalog 134 includes data stored in one or more cloud object storage services, such as one or more Amazon Web Services (AWS)-based Simple Storage Service (S3) buckets. In some implementations, all or a portion of the data is stored in a memory separate from the data catalog 134, such as in the database 130, the vector database 138, and/or another suitable data store.

The vector database 138 stores data associated with vectorized data, such as vectorized versions of search queries, vectorized versions of user feedback, vectorized versions of data asset summaries, vectorized versions of anticipated queries, or any other suitable data associated with vectorized data. In some instances, tokenized versions of such data are also stored in the vector database 138. The vectorized data may be stored in the vector database 138 as dense vector fields in the form of a hierarchical navigable small world (HNSW) graph. In some implementations, the vector database 138 is an Elasticsearch vector database, or another suitable vector database, such as Pinecone, Milvus, Chroma, Weaviate, Deep Lake, Qdrant, Pgvector, Faiss, ClickHouse, Apache Solr, Vespa, Vald, OpenSearch, Apache Cassandra, or the like. As further described below, certain of the vectorized data may be stored as metadata for corresponding data assets. For instance, user feedback received about a particular search result (e.g., linked to a particular data asset) may be vectorized and stored in the vector database 138 as metadata for the particular data asset. Similarly, the vectorized summaries and anticipated queries may also be stored in the vector database 138 as metadata for their associated data assets. In various implementations, the vector database 138 may be a part of or separate from the database 130 and/or the data catalog 134. In some instances, the vector database 138 includes data stored in one or more cloud object storage services, such as one or more Amazon Web Services (AWS)-based Simple Storage Service (S3) buckets. In some implementations, all or a portion of the data is stored in a memory separate from the vector database 138, such as in the database 130, the data catalog 134, and/or another suitable data store.

The LLM 140 may be any suitable generative artificial intelligence (AI) model trained on a large corpus of text to generate written responses, answer questions, and assist with various language-related tasks. To note, the LLM 140 may use various AI accelerators to process vast amounts of textual data (e.g., from the internet), utilize artificial neural networks (ANNs) with millions to billions or even trillions of weights or parameters, be trained through self-supervised and/or semi-supervised methods, incorporate one or more aspects of the transformer architecture and/or mixture of experts (MoE), operate in part based on predicting a next token or word from an input, perform various natural language processing (NLP) tasks, and include multiple layers of transformer blocks configured using aspects of deep learning to recognize and generate language patterns by processing the vast amounts of textual data using the billions or even trillions of parameters or weights. Example LLMs may include OpenAI's ChatGPT, Google's Bard (PaLM) and/or Gemini, Meta's LLaMa, BigScience's BLOOM, Baidu's Ernie 3.0 Titan, Anthropic's Claude, or another suitable type of ML-based neural network compatible with prompt engineering techniques.

The prompting engine 150 may be used in conjunction with the LLM 140 to generate summaries for the plurality of data assets. Specifically, the prompting engine 150 may use the LLM 140 to generate a summary for each of the data assets by systematically processing the associated metadata. As a non-limiting example, initially, comprehensive metadata for each data asset is collected and stored (e.g., in the data catalog 134). The metadata may include information about each data asset such as administrative details, description, account numbers, document status, mapping names, classification status, column lists, comments, data usage statistics, hierarchy information, access times, write times, ownership details, parameters, partition keys, retention policies, and the like. Selected portions of the metadata are then fed into the LLM 140 (e.g., via a preconfigured prompting pipeline), and the LLM 140 is prompted to generate concise summaries for each data asset. An example selected set of inputs to the LLM 140 for a given data asset may include the given data asset's name, type, title, description, and any associated user comments, thereby providing the LLM 140 with information particularly relevant to summarizing a purpose and content of the given data asset. An example LLM “summary” output for the given data asset may be “This hive table compiles all ‘X’ platform invoices, sourced from user entries in ‘Y’ business interface, and generated from the ‘Z’ application as of ABC date,” where X, Y, Z, and ABC represent specific details dynamically inferred by the LLM 140 based on the input metadata.

The prompting engine 150 may also be used in conjunction with the LLM 140 to generate anticipated queries for the plurality of data assets. Specifically, the prompting engine 150 may use the LLM 140 to generate anticipated queries for each of the data assets based on the summaries described above. In some implementations, the prompting engine 150 prompts the LLM 140 using a chain of thought (CoT) technique. For instance, the prompting engine 150 may prompt the LLM 140 to use step-by-step logic to understand the summary generated for a given data asset, and then to generate questions and/or statements that the LLM 140 predicts that users will enter into a search query when the given data asset would be a relevant result. For the example described above, where the generated summary is “This hive table compiles all ‘X’ platform invoices, sourced from user entries in ‘Y’ business interface, and generated from the ‘Z’ application as of ABC date,” a portion of an example LLM “anticipated queries” output for the given data asset may include “*Give me the tables that have details on invoices generated from ‘Z’; *What are the tables that have invoices payable from ‘ABC’ date?; *Which tables include invoices?; *Provide tables related to ‘Y’ business interface.” In other words, the prompting engine 150 uses the LLM 140 to generate queries that anticipate the types of queries users may input when searching for a particular data asset. By using the CoT technique and feeding the summary back to the LLM 140, the prompting engine 150 obtains useful information in plain language that can be stored as additional metadata for the data asset—that is, both the summaries and the anticipated queries are linked to their respective data assets in the data catalog 134 and/or the vector database 138, thereby enhancing the effectiveness of contextual semantic searches utilizing vector-based matching techniques, as further described below.

The sentence transformer 160 may be any suitable model architecture or ML-framework for generating sentence embeddings using NLP techniques. Specifically, the sentence transformer 160 is configured to process input (e.g., sentences, paragraphs, images, etc.) to generate dense vector representations (or “embeddings”) of the input. The dense vectors may be (e.g., fixed-sized) arrays of (e.g., floating-point) numbers—where each number represents a feature learned from the data—that can be used in various applications, such as search, clustering, information retrieval, and the like. In some implementations, the dense vectors are comprised of ones and zeroes. In some implementations, the sentence transformer 160 is a fine-tuned version of a transformer-based model, such as Bidirectional Encoder Representations from Transformers (BERT), Robustly Optimized BERT Pretraining Approach (ROBERTa), DistilBERT, XLNet, or another suitable model trained to output semantically meaningful sentence embeddings from sentence input by bringing embeddings of similar sentences closer together in a vector space while pushing dissimilar sentence embeddings further apart in the vector space. As one example, the sentence transformer 160 may be the open-source HuggingFace Sentence Transformer.

The transforming module 170 may be used in conjunction with the sentence transformer 160 to tokenize and/or vectorize search queries. Specifically, the transforming module 170 may use the sentence transformer 160 to tokenize a search query and vectorize the tokenized version of the search query. As a non-limiting example, the transforming module 170 inputs (or “feeds”) a user's search query (e.g., a raw text string, “Which tables are for invoices?”) to the sentence transformer 160, the raw text string is converted into tokens, and the tokens are converted into one or more vector embeddings. As further described below, the tokenized search query may be used in conjunction with the relevancy scoring algorithm, and the vectorized search query may be used in conjunction with the semantic scoring algorithm.

The transforming module 170 may also be used in conjunction with the sentence transformer 160 to tokenize and/or vectorize the summaries and anticipated queries described above. Specifically, the transforming module 170 may use the sentence transformer 160 to tokenize the summaries and anticipated queries, and then to vectorize the tokenized summaries and tokenized sets of anticipated queries. Continuing the example above, the transforming module 170 may input the summary generated for a given data asset (e.g., “This hive table compiles all ‘X’ platform invoices, sourced from user entries in ‘Y’ business interface, and generated from the ‘Z’ application as of ABC date”) and anticipated queries generated for the data asset (e.g., “*Give me the tables that have details on invoices generated from ‘Z’; *What are the tables that have invoices payable from ‘ABC’ date?; *Which tables include invoices?; *Provide tables related to ‘Y’ business interface.”) to the sentence transformer 160, and the sentence transformer 160 may convert the raw text strings of the input into tokens, and convert the tokens into vector embeddings. This process may repeat for each data asset for which a summary and/or a set of anticipated queries is generated (e.g. in a vectorization processing pipeline).

The transforming module 170 may also be used in conjunction with the sentence transformer 160 to tokenize and/or vectorize user feedback, such as by tokenizing the feedback and vectorizing the tokenized feedback. For example, if a user submits a raw text comment about a search result via the interface 120 (e.g., “this table helped me in finding invoices from the ‘Q’ application”), the transforming module 170 may use the sentence transformer 160 to convert the raw text comment into tokens, vectorize the tokens, and then store the vector embeddings in the vector database 138 in association with the corresponding data asset. As another example, if a user simply approves of a particular search result (e.g., with a “thumbs up”) but provides no textual feedback, the transforming module 170 may instead retrieve the user's search query (which could be “provide tables that can help me find invoices generated from ‘Q’ application” for this example), tokenize and vectorize the search query, and to store the vectorized search query as metadata in the vector database 138 linked to the data asset corresponding to the particular search result. In instances where the corresponding data asset has yet to be associated with any user feedback, a new metadata field (e.g., ‘user_feedback’) may be created for the data asset in which the vectorized search query is stored. Thereafter, if a subsequent user enters a similar query (e.g., “what are tables related to invoices for ‘Q’ application?”), the semantic scoring algorithm (further described below) will apply greater weight to the particular search result because the previous user's search query (i.e., “provide tables that can help me find invoices generated from ‘Q’ application”) was already vectorized and stored in the user_feedback metadata field and associated with the particular data asset.

As mentioned above, the transforming module 170 may be used to store the vector embeddings as dense vectors in the vector database 138. In some implementations, the transforming module 170 stores the dense vectors in the vector database 138 in the form of an HNSW graph, thereby enhancing performance (e.g., for vector matching) during approximate k-nearest neighbors (KNN) (or ANN) searches, for example. By storing the dense vectors in the form of an HNSW graph, the efficiency of semantic search processes is significantly improved, particularly for large datasets. For instance, an exact vector-based search within a database of one million vectors may take five seconds or longer, whereas an approximate vector-based search using the HNSW graph may reduce the search time to 200 milliseconds. In other words, the HNSW graph allows for an approximate search for vector matches, thus enabling an ANN search algorithm to efficiently approximate vector matches, thereby reducing retrieval times. To note, because the token-based searches described herein are also associated with relatively fast search times (e.g., 200 milliseconds), and because the final search rankings are generated from a combination of search results (e.g., both token-based and vector-based searches), storing the dense vectors in the HNSW graph format enables the search results ranking system to identify contextually relevant and semantically meaningful search results at approximately the same time, thus enabling the search results ranking system to efficiently generate augmented search results (e.g., in near real-time with a user entering a search query).

The querying module 174 may be used to generate and submit database queries to the data catalog 134 and/or the vector database 138. For instance, the querying module 174 may submit a token query that matches the tokenized version of a search query against the data assets and/or their corresponding metadata stored in the data catalog 134 and/or the vector database 138. As one example, a user's search query may include “details-transactions % abc” and be converted into search tokens (e.g., ‘details’, ‘transactions’, and ‘abc’) and matched against the data assets on particular metadata fields, such as description, qualifiedName, title, and/or other suitable string fields. Relevancy subscores may be generated based on results of the matching, as described below in connection with the relevancy scoring algorithm.

The querying module 174 may also be used to generate and submit vector-based database queries to the vector database 138. For instance, the querying module 174 may submit vector queries matching the vectorized version of a search query against the data assets and any vectorized summaries, anticipated queries, or user feedback (e.g., in the ‘user_feedback’ field discussed above) stored in association with the data assets. Thus, in some instances, the querying module 174 may compare the user's vectorized search query against three sets of vectors associated with the data assets, i.e., the summary vectors, the anticipated queries vectors, and the user-feedback vectors. By matching the vectorized version of the search query against multiple sets of vectors, additional relevant and meaningful data assets are identified and can be included within the results even when such data assets are not identified by the token query described above (e.g., based on keyword matching by name, pathname, description, or the like) or even when such data assets do not have associated descriptions. To note, users that prefer to search for data assets using familiar keywords or specialized context are still serviced by the simultaneous token-based search described above.

The scoring engine 180 may be used to generate scores (or “subscores”) for data assets based on results of the token queries and vector queries described above. The scores may be generated using various scoring algorithms 184, such as a relevancy scoring algorithm, a semantic scoring algorithm, a popularity scoring algorithm, a final scoring algorithm, or the like.

Using the relevancy scoring algorithm, the scoring engine 180 generates relevancy subscores for the data assets based on results of the token queries described above. In some implementations, multiple relevancy scoring algorithms are used in generating the relevancy subscores, such as portions of the relevancy scoring techniques described in U.S. patent application Ser. No. 17/510,714 (now U.S. Pat. No. 11,630,829) entitled “AUGMENTING SEARCH RESULTS BASED ON RELEVANCY AND UTILITY” and filed on Oct. 26, 2021. The relevancy subscores are retained for further processing.

Using the semantic scoring algorithm, the scoring engine 180 generates semantic subscores for the data assets based on results of the vector queries described above. As mentioned, the semantic scoring algorithm incorporates one or more ANN search techniques and an HNSW algorithm. In some implementations, the scoring engine 180 assigns equal weightage to the “summary” vector query results and “anticipated queries” vector query results, thereby ensuring that, regardless of the nature of the user's input (e.g., a direct question, a descriptive search term, a command, etc.), the search results ranking system can identify data assets with high contextual relevance and semantic meaning. In some other implementations, the scoring engine 180 assigns relatively lower weightage to the “user-feedback” vector query results, thus ensuring that user feedback is incorporated into the semantic search results (improving them over time) while avoiding overcorrection based on feedback from initial exploratory searches by new users who may still be developing their understanding of the system. As a non-limiting example, 40% of the semantic subscore for a given data asset may be attributed to results for the “summary” vectors, 40% of the semantic subscore for the given data asset may be attributed to results for the “anticipated queries” vectors, and 20% of the semantic subscore for the given data asset may be attributed to results for the “user-feedback” vectors. The semantic subscores are retained for further processing.

In some implementations, users themselves are associated with certain metadata (e.g., in the database 130), such as a role of the user (e.g., data engineer, data scientist, etc.), teams the user belongs to, tables historically viewed by the user, tables historically viewed by members of the user's team, and the like. This user metadata may also be used (e.g., by the scoring engine 180) in generating the semantic subscores. For instance, a data scientist that frequently accesses entertainment-based data assets may cause the scoring engine 180 to generate relatively higher semantic subscores for entertainment-based data assets when generating search results for the data scientist, thereby enhancing the relevance of the particular user's search results. Similarly, a particular team of users that often manage marketing data may more often be presented with tables relevant to consumer behavior and advertising metrics, as the scoring engine 180 will generate higher semantic subscores for such data assets based on the team's metadata.

The scoring engine 180 is also used to identify contextually relevant results for a search query based on the relevancy subscores and semantic subscores, such as a combination of the relevancy subscore and semantic subscore (or a “combined score”) for each data asset. In some implementations, the scoring engine 180 identifies the contextually relevant results based on the highest scoring data assets in each of a plurality of database shards. For instance, the scoring engine 180 may identify a top number of highest combined scoring data assets in each shard. In some other implementations, such as when the total number of data assets is relatively small, the top combined scoring data assets may be identified within a single database.

Using the popularity scoring algorithm, the scoring engine 180 generates popularity subscores for the contextually relevant results. In some implementations, multiple utility scoring algorithms are used in generating the popularity subscores, such as portions of the utility scoring techniques described in U.S. patent application Ser. No. 17/510,714 (now U.S. Pat. No. 11,630,829) entitled “AUGMENTING SEARCH RESULTS BASED ON RELEVANCY AND UTILITY” and filed on Oct. 26, 2021. For instance, the popularity subscore may incorporate overall popularity of a given data asset (a “popularity score”), a “query score,” and a “view score,” where each of said scores may be weighted, such as by 1.5, 1.0, and 0.5, respectively. The popularity subscores are retained for further processing.

The scoring engine 180 generates an augmented score for each of the contextually relevant results based on a combination of the subscores described above. For instance, the augmented score for a given data asset may be determined based on combining the “combined score” described above for the given data asset with the popularity subscore generated for the given data asset. That is, based on the relevancy subscores and the semantic subscores, the scoring engine 180 identifies a particular number of data assets in each database shard, and then uses the popularity subscores to generate the augmented scores. In some implementations, the scoring engine 180 dampens the popularity subscore using an exponential or logarithmic technique. For example, the formula for calculating the augmented score for a given data asset may be “relevancy subscore”+“semantic subscore”+log (0.1+“popularity subscore”), where the logarithmic (e.g., “Math.log”) function prevents relatively high popularity scores from disproportionately influencing the overall score, and the inclusion of 0.1 addresses the mathematical issue where the logarithm of zero is undefined (e.g., thus avoiding potential exceptions being thrown by the system).

The ranking engine 190 may be used to rank the contextually relevant results based on the augmented scores generated by the scoring engine 180. Specifically, the ranking engine 190 generates final search results (or “augmented search results”) for the search query based on the data assets associated with the highest augmented scores. For instance, a select number of the highest scoring data assets (e.g., in descending order) may be provided to the user's computing device via the interface 120. As the search results ranking system is optimized (e.g., in the manners described above) to identify the most relevant, semantically meaningful, and popular data assets in near real-time, the ranking engine 190 may provide (e.g., display) the augmented search results to the user in near real-time, such as while the user is entering the search query and/or immediately after the user has entered the search query.

The LLM 140, the prompting engine 150, the sentence transformer 160, the transforming module 170, the querying module 174, the scoring engine 180, the scoring algorithms 184, and/or the ranking engine 190 are implemented in software, hardware, or a combination thereof. In some implementations, any one or more of the LLM 140, the prompting engine 150, the sentence transformer 160, the transforming module 170, the querying module 174, the scoring engine 180, the scoring algorithms 184, or the ranking engine 190 is embodied in instructions that, when executed by the processor 110, cause the system 100 to perform operations. In various implementations, the instructions of one or more of said components, the interface 120, the data catalog 134, and/or vector database 138, are stored in the memory 114, the database 130, or a different suitable memory, and are in any suitable programming language format for execution by the system 100, such as by the processor 110. It is to be understood that the particular architecture of the system 100 shown in FIG. 1 is but one example of a variety of different architectures within which aspects of the present disclosure can be implemented. For example, in some implementations, components of the system 100 are distributed across multiple devices, included in fewer components, and so on. While the below examples related to generating augmented search results are described with reference to the system 100, other suitable system configurations may be used.

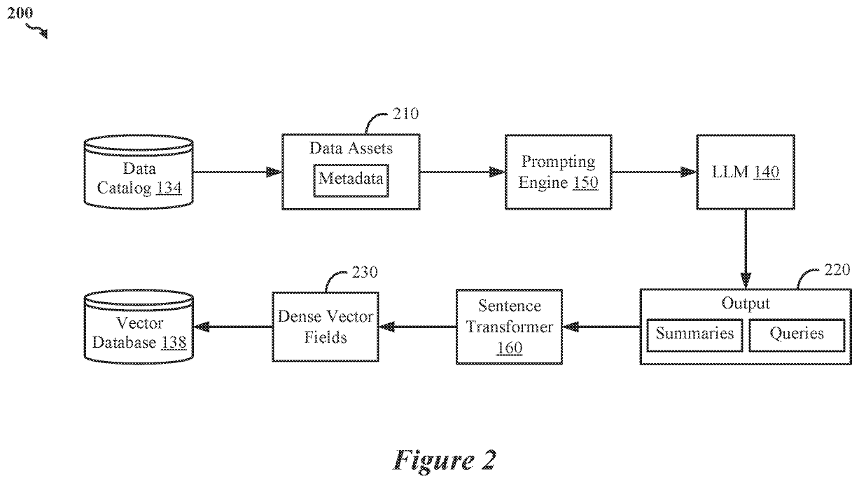

FIG. 2 shows a high-level overview of an example process flow 200 employed by a system, according to some implementations, during which a vector database (e.g., the vector database 138) is constructed for use in generating augmented search results. In various implementations, the system incorporates one or more (or all) aspects of the system 100. In some implementations, various aspects described with respect to FIG. 1 are not incorporated, such as the transforming module 170, the querying module 174, the scoring engine 180, the scoring algorithms 184, and/or the ranking engine 190.

Prior to block 210, a plurality of data assets, along with associated metadata, are stored in the data catalog 134. At block 210, some or all of the data assets, along with their metadata, are identified in the data catalog 134, and submitted to a prompting processing pipeline. Specifically, the prompting engine 150 uses the large language model (LLM) 140 to generate, for each of the data assets, a summary and some number of anticipated queries based on the summary, which is shown as LLM output at block 220. In some implementations, the LLM 140 is prompted to generate the anticipated queries using a chain of thought (CoT) technique. Thereafter, sentence transformer 160 is used to transform each of the summaries and anticipated queries into dense vectors, as shown at block 230. The dense vectors (i.e., the vectorized versions of the summaries and anticipated queries) are stored in the vector database 138. In some implementations, the dense vectors are stored as a hierarchical navigable small world (HNSW) graph.

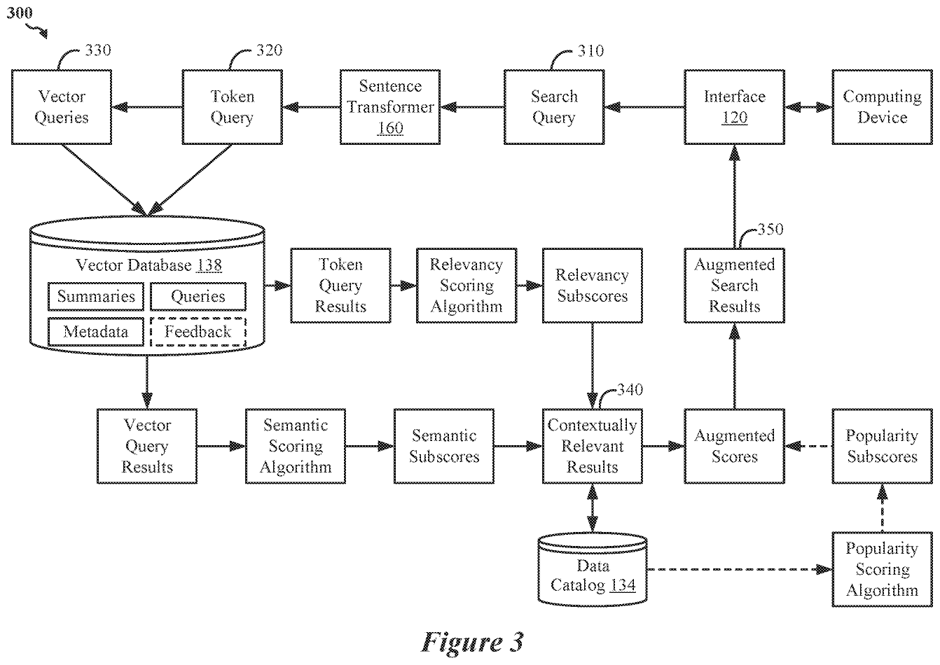

FIG. 3 shows a high-level overview of an example process flow 300 employed by a system, according to some implementations, during which augmented search results are generated. In various implementations, the system incorporates one or more (or all) aspects of the system 100. In some implementations, various aspects described with respect to FIG. 1 are not incorporated, such as the LLM 140 and/or the prompting engine 150.

Prior to block 310, the system receives a transmission over a communications network (e.g., via the interface 120) from a computing device associated with a user of the search results ranking system. The transmission includes a search query, as shown at block 310. After block 310, the sentence transformer 160 is used to generate a tokenized version of the search query and a vectorized version of the tokenized version of the search query.

At block 320, the querying module 174 is used to submit a token query to the vector database 138. In addition, or in the alternative, the token query is submitted to the data catalog 134. In either case, the token query matches the tokenized version of the search query against metadata stored in association with a plurality of data assets. Thereafter, the scoring engine 180 uses the relevancy scoring algorithm to generate relevancy subscores for the data assets.

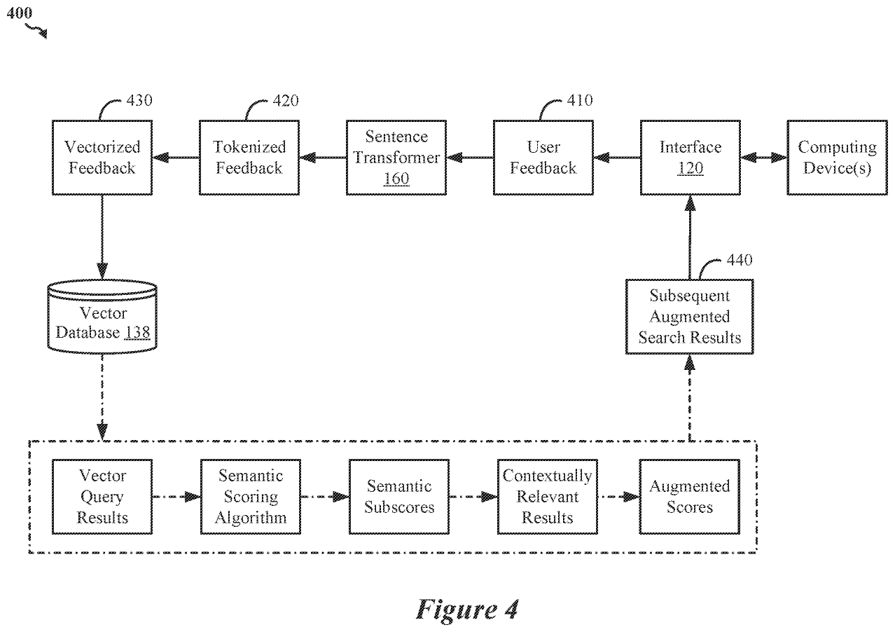

At block 330, the querying module 174 is used to submit one or more vector queries to the vector database 138. The one or more vector queries match the vectorized version of the search query against vectorized summaries and/or vectorized anticipated queries generated for the data assets and stored in the vector database 138 (as described in connection with FIG. 2). In some implementations not shown, the vector queries also match the vectorized version of the search query against vectorized user feedback generated for the plurality of data assets and stored in the vector database 138 (as described in connection with FIG. 4). Thereafter, the scoring engine 180 uses the semantic scoring algorithm to generate semantic subscores for the plurality of data assets. In some implementations, the semantic scoring algorithm incorporates one or more approximate nearest neighbor (ANN) techniques.

At block 340, results that are contextually relevant to the search query (i.e., ones of the plurality of data assets) are identified based on the relevancy subscores and the semantic subscores. In some implementations, the contextually relevant results are distributed across a plurality of database shards. Thereafter, in some implementations, the scoring engine 180 uses the popularity scoring algorithm to generate a popularity subscore for each of the contextually relevant results. Augmented scores are generated for the contextually relevant results based on a combination of the relevancy subscores, the semantic subscores, and in such implementations, the popularity subscores.

At block 350, the ranking engine 190 generates augmented search results for the search query based on the augmented scores. The augmented search results are provided to the user's computing device via the interface 120.

FIG. 4 shows a high-level overview of an example process flow 400 employed by a system, according to some implementations, during which subsequent augmented search results are generated based on user feedback. In various implementations, the system incorporates one or more (or all) aspects of the system 100. In some implementations, various aspects described with respect to FIG. 1 are not incorporated, such as the LLM 140 and/or the prompting engine 150.

Prior to block 410, the system receives a transmission over a communications network (e.g., via the interface 120) from a computing device associated with a user of the search results ranking system. The transmission includes user feedback about one or more search results provided to the user, as shown at block 410, such as a thumbs up indicating that a particular search result was useful, accurate, or the like. After block 410, the sentence transformer 160 is used to generate a tokenized version of the user's associated search query, as shown at block 420, and a vectorized version of the search query, as shown at block 430. After block 430, the vectorized search query is stored in the vector database 138 as metadata for the corresponding data asset. As shown in the dashed box, the vectorized search query is used when generating subsequent vector query results. Specifically, the scoring engine 180 in conjunction with the semantic scoring algorithm may incorporate the vectorized search query when generating semantic subscores for the plurality of data assets, thus impacting the contextually relevant results that are generated for the subsequent (similar) search query, thus impacting the augmented scores that are generated for the subsequent search query, thus impacting the subsequent augmented search results that are generated for the subsequent search query, as shown at block 440. The subsequent augmented search results are provided to the user's computing device via the interface 120.

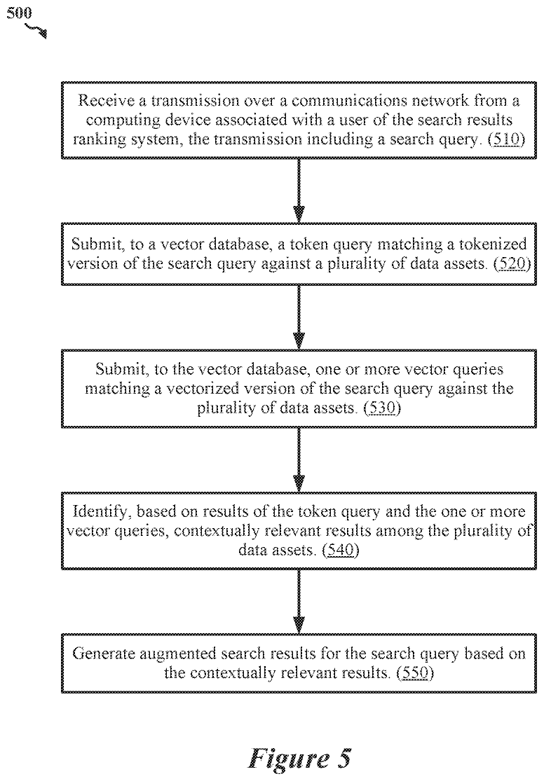

FIG. 5 shows a high-level overview of an example process flow 500 employed by the system 100 of FIG. 1 and/or the systems described with respect to FIGS. 2-4, according to some implementations, during which augmented search results are generated. At block 510, the system 100 receives a transmission over a communications network from a computing device associated with a user of the search results ranking system, the transmission including a search query. At block 520, the system 100 submits, to a vector database, a token query matching a tokenized version of the search query against a plurality of data assets. At block 530, the system 100 submits, to the vector database, one or more vector queries matching a vectorized version of the search query against the plurality of data assets. At block 540, the system 100 identifies, based on results of the token query and the one or more vector queries, contextually relevant results among the plurality of data assets. At block 550, the system 100 generates augmented search results for the search query based on the contextually relevant results.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logics, logical blocks, modules, circuits, and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or any conventional processor, controller, microcontroller, or state machine. A processor also may be implemented as a combination of computing devices such as, for example, a combination of a DSP and a microprocessor, a plurality of microprocessors, one or more microprocessors in conjunction with a DSP core, or any other suitable configuration. In some implementations, particular processes and methods are performed by circuitry specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification can also be implemented as one or more computer programs, i.e., one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to other implementations without departing from the spirit or scope of this disclosure. For example, while the figures and description depict an order of operations in performing aspects of the present disclosure, one or more operations may be performed in any order or concurrently to perform the described aspects of the disclosure. In addition, or in the alternative, a depicted operation may be split into multiple operations, or multiple operations that are depicted may be combined into a single operation. Thus, the claims are not intended to be limited to the implementations shown herein but are to be accorded the widest scope consistent with this disclosure and the principles and novel features disclosed herein.

What is claimed is:

1. A method for generating augmented search results, the method performed by one or more processors of a search results ranking system and comprising:
receiving a transmission over a communications network from a computing device associated with a user of the search results ranking system, the transmission including a search query;
submitting, to a vector database, a token query matching a tokenized version of the search query against a plurality of data assets;
submitting, to the vector database, one or more vector queries matching a vectorized version of the search query against the plurality of data assets;
identifying, based on results of the token query and the one or more vector queries, contextually relevant results among the plurality of data assets; and
generating augmented search results for the search query based on the contextually relevant results.

2. The method of claim 1, wherein the search query is submitted via an interface, wherein the contextually relevant results are distributed across a plurality of database shards, and the method further comprising:
tokenizing the search query using a sentence transformer;
vectorizing the tokenized version of the search query using the sentence transformer; and
outputting, via the interface, the augmented search results to the user.

3. The method of claim 1, the method further comprising:
storing the plurality of data assets in a data catalog, wherein each of the plurality of data assets is associated with at least some metadata in the data catalog, and wherein the token query matches the tokenized version of the search query against the metadata.

4. The method of claim 1, the method further comprising:
generating, using a relevancy scoring algorithm, one or more relevancy subscores for the plurality of data assets based on results of the token query, wherein the contextually relevant results are generated based in part on the relevancy subscores.

5. The method of claim 1, the method further comprising:
generating, using a large language model (LLM), a summary for each of the plurality of data assets based on metadata associated with the plurality of data assets;
generating, using the LLM, anticipated queries for each of the plurality of data assets based on the generated summaries, wherein the LLM is prompted to generate the anticipated queries using a chain of thought technique;
tokenizing, using a sentence transformer, the generated summaries and the generated sets of anticipated queries;
vectorizing, using the sentence transformer, the tokenized summaries and the tokenized sets of anticipated queries; and
storing the vectorized summaries and the vectorized sets of anticipated queries in the vector database.

6. The method of claim 5, wherein the vectorized summaries and the vectorized sets of anticipated queries are stored in the vector database as dense vector fields, and wherein the dense vector fields are stored in the vector database as a hierarchical navigable small world (HNSW) graph.

7. The method of claim 5, wherein the one or more vector queries include at least a matching of the vectorized version of the search query against the vectorized summaries and a matching of the vectorized version of the search query against the vectorized sets of anticipated queries, the method further comprising:
generating, using a semantic scoring algorithm, one or more semantic subscores for the plurality of data assets based on results of the one or more vector queries, wherein the contextually relevant results are generated based in part on the semantic subscores.

8. The method of claim 7, wherein the semantic scoring algorithm incorporates one or more approximate nearest neighbor (ANN) techniques.

9. The method of claim 1, the method further comprising:
generating a popularity subscore for each of the contextually relevant results using a popularity scoring algorithm;
generating an augmented score for each of the contextually relevant results based on a combination of the results of the token query, the results of the one or more vector queries, and the popularity subscore; and
ranking the contextually relevant results based on the augmented scores, wherein generating the augmented search results is based on the ranking.

10. The method of claim 1, the method further comprising:
receiving user feedback about one of the augmented search results;
tokenizing the user feedback using a sentence transformer;
vectorizing the tokenized user feedback using the sentence transformer;
storing, in the vector database, the vectorized user feedback as metadata for the data asset corresponding to the one of the augmented search results;
receiving a subsequent search query; and
generating subsequent augmented search results for the subsequent search query based in part on the vectorized user feedback.

11. A system for generating augmented search results, the system comprising:
one or more processors; and
at least one memory coupled to the one or more processors and storing instructions that, when executed by the one or more processors, cause the system to perform operations including:
receiving a transmission over a communications network from a computing device associated with a user of the search results ranking system, the transmission including a search query;
submitting, to a vector database, a token query matching a tokenized version of the search query against a plurality of data assets;
submitting, to the vector database, one or more vector queries matching a vectorized version of the search query against the plurality of data assets;
identifying, based on results of the token query and the one or more vector queries, contextually relevant results among the plurality of data assets; and
generating augmented search results for the search query based on the contextually relevant results.

12. The system of claim 11, wherein the search query is submitted via an interface, wherein the contextually relevant results are distributed across a plurality of database shards, and wherein execution of the instructions causes the system to perform operations further including:
tokenizing the search query using a sentence transformer;
vectorizing the tokenized version of the search query using the sentence transformer; and
outputting, via the interface, the augmented search results to the user.

13. The system of claim 11, wherein execution of the instructions causes the system to perform operations further including:
storing the plurality of data assets in a data catalog, wherein each of the plurality of data assets is associated with at least some metadata in the data catalog, and wherein the token query matches the tokenized version of the search query against the metadata.

14. The system of claim 11, wherein execution of the instructions causes the system to perform operations further including:
generating, using a relevancy scoring algorithm, one or more relevancy subscores for the plurality of data assets based on results of the token query, wherein the contextually relevant results are generated based in part on the relevancy subscores.

15. The system of claim 11, wherein execution of the instructions causes the system to perform operations further including:
generating, using a large language model (LLM), a summary for each of the plurality of data assets based on metadata associated with the plurality of data assets;
generating, using the LLM, anticipated queries for each of the plurality of data assets based on the generated summaries, wherein the LLM is prompted to generate the anticipated queries using a chain of thought technique;
tokenizing, using a sentence transformer, the generated summaries and the generated sets of anticipated queries;
vectorizing, using the sentence transformer, the tokenized summaries and the tokenized sets of anticipated queries; and
storing the vectorized summaries and the vectorized sets of anticipated queries in the vector database.

16. The system of claim 15, wherein the vectorized summaries and the vectorized sets of anticipated queries are stored in the vector database as dense vector fields, and wherein the dense vector fields are stored in the vector database as a hierarchical navigable small world (HNSW) graph.

17. The system of claim 15, wherein the one or more vector queries include at least a matching of the vectorized version of the search query against the vectorized summaries and a matching of the vectorized version of the search query against the vectorized sets of anticipated queries, and wherein execution of the instructions causes the system to perform operations further including:
generating, using a semantic scoring algorithm, one or more semantic subscores for the plurality of data assets based on results of the one or more vector queries, wherein the contextually relevant results are generated based in part on the semantic subscores.

18. The system of claim 17, wherein the semantic scoring algorithm incorporates one or more approximate nearest neighbor (ANN) techniques.

19. The system of claim 11, wherein execution of the instructions causes the system to perform operations further including:
generating a popularity subscore for each of the contextually relevant results using a popularity scoring algorithm;
generating an augmented score for each of the contextually relevant results based on a combination of the results of the token query, the results of the one or more vector queries, and the popularity subscore; and
ranking the contextually relevant results based on the augmented scores, wherein generating the augmented search results is based on the ranking.

20. The system of claim 11, wherein execution of the instructions causes the system to perform operations further including:
receiving user feedback about one of the augmented search results;
tokenizing the user feedback using a sentence transformer;
vectorizing the tokenized user feedback using the sentence transformer;
storing, in the vector database, the vectorized user feedback as metadata for the data asset corresponding to the one of the augmented search results;
receiving a subsequent search query; and
generating subsequent augmented search results for the subsequent search query based in part on the vectorized user feedback.
